(19) United States
(12) Patent Application Publication
(10) Pub. No.: US 2007/0003906 A1
(43) Pub. Date: Jan. 4, 2007

(54) Intraosseous Drug Delivery Portal, Injector, and System

(75) Inventor: Rolfe C. Anderson, Saratoga, CA (US)

Correspondence Address: DEWIPAT INCORPORATED, P.O. BOX 1017, CYPRESS, TX, 77410-1017, US

(73) Assignee: ALZA CORPORATION, Mountain View, CA (US)

(21) Appl. No.: 11/427,373

(22) Filed: Jun. 29, 2006

Related U.S. Application Data
(60) Provisional application No. 60/695,626, filed on Jun. 30, 2005.

(51) Int. Cl. A61C 5/00

(52) U.S. Cl. 433/215

(57) ABSTRACT

A system for intraosseous drug delivery includes a reservoir containing a drug, an injection port which provides a route through which the drug can be delivered to a root of a tooth from an exterior of the tooth, and an injection needle in communication with the reservoir and adapted for insertion into the injection port. A portal for intraosseous drug delivery includes a prosthetic body adapted to mate with a tooth and a port formed in the prosthetic body such that when the prosthetic body mates with the tooth a route is formed through which a drug can be delivered from an exterior of the prosthetic body to a root of the tooth.

### BACKGROUND OF THE INVENTION

The invention relates generally to controlled or patterned drug delivery methods and systems.

Many drugs of therapeutic importance are taken parenterally. For example, insulin is necessary for regulating carbohydrate metabolism by reducing blood glucose levels. A systematic deficiency in insulin causes diabetes. Survival of diabetic patients depends on frequent and long term administration of insulin to maintain acceptable blood glucose levels. Insulin may be administered intravenously or intramuscularly; however, long term treatment relies on subcutaneous injection (typically into the abdomen or upper thighs). In order to maintain acceptable blood glucose levels, it is often necessary to inject insulin at least once or twice per day with supplemental injections of rapid-acting insulin being administered when necessary. Aggressive treatment of diabetes can require even more frequent injections.

Subcutaneous injection is the primary mechanism for administering insulin to diabetic patients. This administration route, however, has limitations. For example, many patients find it difficult and burdensome to inject themselves as frequently as necessary to maintain acceptable blood glucose levels. Such reluctance can lead to non-compliance, which in the most serious cases can be life-threatening. In addition, repeated injection at a single location on the body can result in lumps or small dents, called “lipodystrophies.”

There have been attempts to administer insulin orally, nasally, vaginally, and rectally. While these techniques may avoid the discomfort and poor compliance associated with subcutaneous injection, they each have their own limitations. For example, intra-rectal and intra-vaginal are inconvenient and uncomfortable, and the latter is not available to the entire population of diabetics. On the other hand, intranasal delivery requires the use of potentially toxic “penetration enhancers” to effect passage of insulin across the nasal mucosa, which is characterized by a thick epithelial layer that is resistant to the passage of macromolecules.

From the foregoing, there continues to be a need for improvement in controlled or patterned delivery of drugs to patients.

### SUMMARY OF THE INVENTION

In one aspect, the invention relates to a portal for intraosseous drug delivery which comprises a prosthetic body adapted to mate with a tooth and a port formed in the prosthetic body such that when the prosthetic body mates with the tooth a route is formed through which a drug can be delivered from an exterior of the prosthetic body to a root of the tooth.

In another aspect, the invention relates to an injector for intraosseous drug delivery which comprises a depressible member adapted for insertion between a pair of jaws, a drug cartridge including a reservoir mounted relative to the depressible member such that force can be transferred from the depressible member to the drug cartridge, and an injection needle in communication with the reservoir, wherein drug flows from the reservoir into the injection needle when the depressible member is depressed.

In yet another aspect, the invention relates to a system for intraosseous drug delivery which comprises a reservoir containing a drug, an injection port which provides a route through which the drug can be delivered to a root of a tooth from an exterior of the tooth, and an injection needle in communication with the reservoir and adapted for insertion into the injection port.

In another aspect, the invention relates to a method for intraosseous drug delivery which comprises inserting a needle in a portal formed in a tooth embedded in a jawbone and dispensing a drug into the portal through the needle such that the drug flows to the jawbone through a channel defined between the portal and the jawbone.

Other features and advantages of the invention will be apparent from the following description and the appended claims.

### BRIEF DESCRIPTION OF THE DRAWINGS

FIG. 1A illustrates a tooth modified to include a portal for intraosseous drug delivery according to an embodiment of the invention.

FIGS. 1B and 1C are cross-sectional views of a tooth modified to include a portal for intraosseous drug delivery according to an embodiment of the invention.

FIG. 1D shows an exploded view of a prosthetic crown including an injection port for intraosseous drug delivery.

FIG. 1E shows an injection port for intraosseous drug delivery with a dental implant according to one embodiment of the invention.

FIG. 1F shows drug delivered to a root of a tooth via an injection port formed in the tooth.

FIGS. 2A-2J show different views of a bite-activated injector for delivering a drug into an injection port adapted for intraosseous drug delivery according to one embodiment of the invention.

### DETAILED DESCRIPTION OF THE INVENTION

The invention will now be described in detail with reference to a few preferred embodiments, as illustrated in accompanying drawings. In the following description, numerous specific details are set forth in order to provide a thorough understanding of the invention. However, it will be apparent to one skilled in the art that the invention may be practiced without some or all of these specific details. In other instances, well-known features and/or process steps have not been described in detail in order to not unnecessarily obscure the invention. The features and advantages of the invention may be better understood with reference to the drawings and discussions that follow.

An intraosseous drug delivery system according to embodiments of the invention delivers a drug to a jawbone via a root of a tooth. The drug delivered to the jawbone may be absorbed into the vascular system, thereby reducing or obviating the invasive practice of subcutaneous injection for controlled or patterned drug delivery. An intraosseous drug delivery system according to one embodiment of the invention includes an injection port, a drug reservoir, and an injection needle for delivery of drug from the drug reservoir to the injection port. The injection port provides a route through which drug can be delivered from an exterior of the tooth to the root of the tooth. The tooth is modified to include the injection port. Such modification may include replacing the crown of the tooth with a prosthetic crown including the injection port or modifying the crown of the tooth to include an injection port. A septum may be disposed in the injection port to control entry of unwanted material from the exterior of the tooth to the root system of the tooth.

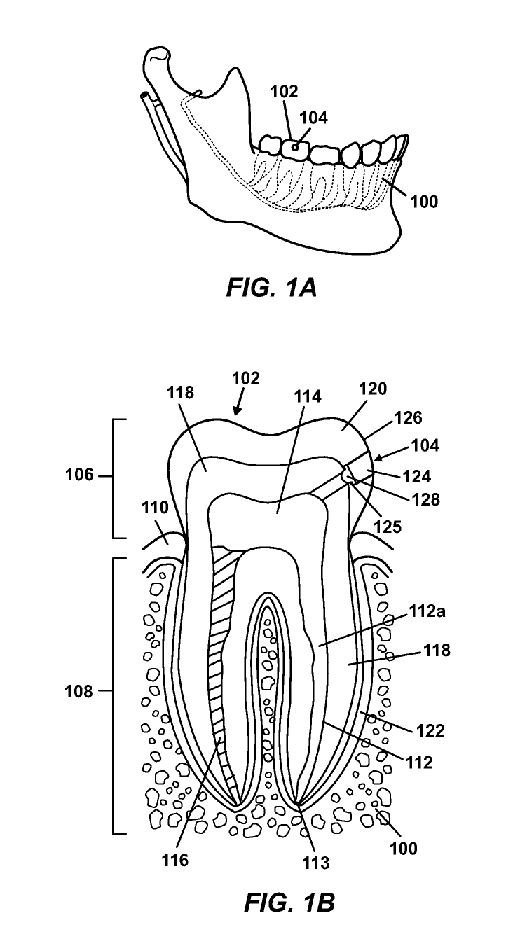

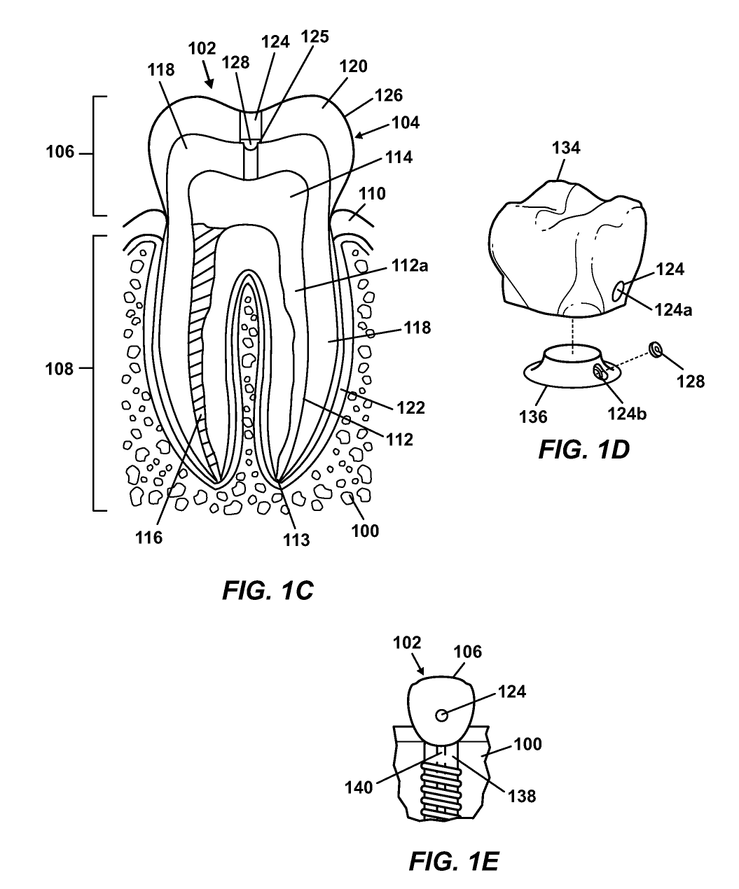

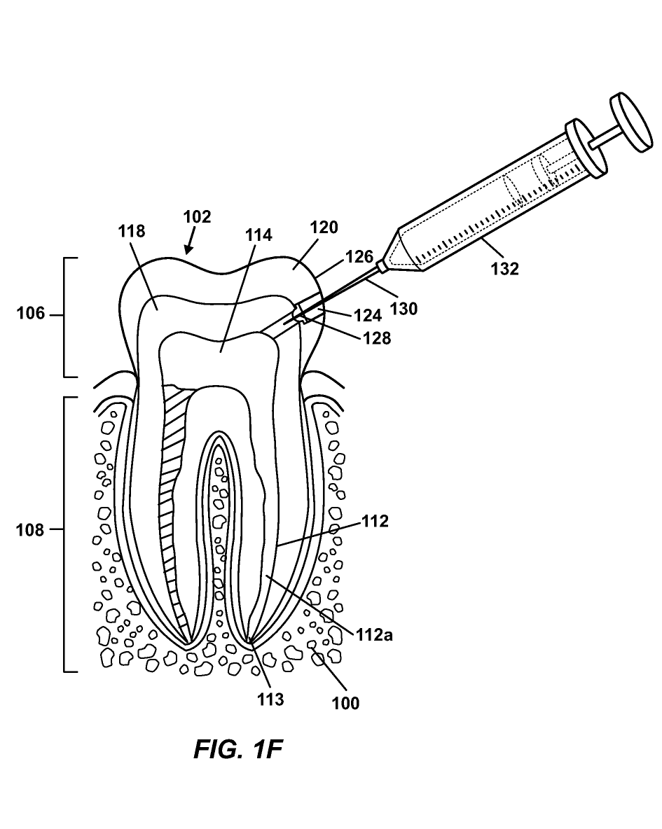

FIG. 1A illustrates a jawbone 100 in which a tooth 102 is embedded. The tooth 102 is modified to include a portal 104 for intraosseous drug delivery according to an embodiment of the invention. FIG. 1B shows a cross-sectional view of the tooth 102. The tooth 102 has a crown 106 and roots 108, which are embedded in a gum socket 110 in the jawbone 100. The term “root” would generally refer to the portion of the tooth that anchors the tooth in the jawbone. In each root 108 is a canal 112 which forms a channel between a central chamber 114 in the crown 106 and the jawbone 100. The canal 112 can communicate with the jawbone 100 through an opening 113 at the tip of the root 108. Pulp and vasculature have been removed from the chamber 114 and root canals 1 12. At least one root canal 112, e.g., root canal 112a, is available for intraosseous communication. The root canal(s) 112 not used for intraosseous communication may be filled with dental cement material or other suitable substantially non-porous material as indicated, for example, at 116. A dentine layer 118 surrounds the chamber 114 and root canals 112. The crown portion of the dentine layer 118 is covered by an enamel layer 120, and the root portion of the dentine layer 118 is covered by cementum 122. The cementum 122 bonds the roots 108 to the jawbone 100.

The portal 104 includes an injection port 124 formed in the crown 106 of the tooth 102. The injection port 124 acts as a non-invasive point of entry and passage of a drug to the jawbone 100. In one embodiment, the injection port 124 extends from an exterior 126 of the crown 106 to the chamber 114, which is in communication with, for example, the root canal 112a. The injection port 124 may simply be a hole drilled in the crown 106. The hole could be drilled from a side of the crown 106 to the chamber 114 as shown, or may be drilled from the top of the crown to the chamber 114 as shown in FIG. 1C. In another embodiment, the injection port 124 is a prosthetic insert, and the crown 106 is modified to receive the prosthetic insert. For example, the prosthetic insert may be a generally hollow cylindrical body made of a biocompatible material such as titanium. The septum 128 could be disposed in the cylindrical body. The crown 106 may include a hole for receiving the prosthetic insert. The injection port (or prosthetic insert) 124 may be permanently secured to the crown 106 by, for example, cement, or may be removably secured to the crown 106, e.g., by friction-fitting or threads.

A septum 128 may be disposed in the injection port 124. The septum 128 may prevent unwanted material, such as debris and bacteria, from reaching the root canal 112a. The wall of the injection port 124 may include a seat 125 for the septum 128. In one example, the septum 128 is a disk made of a flexible, biocompatible material, for example, an elastomeric material.

In another embodiment, the crown 106 may be a prosthetic crown that includes the injection port 124. The prosthetic crown may be permanently secured or removably secured in the gum socket 1 10. In one example, as shown in FIG. 1D, the prosthetic crown 106 may have a cover 134 (corresponding to an enamel layer) and a base 136 (corresponding to a dentine layer). The base 136 may be mounted above the chamber (114 in FIG. 1B). For example, the dentine layer (118 in FIG. 1B) above the chamber 114 could be filed into a stump (not shown), and the base 136 may include a surface for engaging the stump. The cover 134 includes a surface for engaging the base 136. The cover 134 may be mounted on the base 136 so that it is detachable from the base 136 as needed. In this case, the injection port 124 may have two sections 124a, 124b, wherein section 124a is located in the cover 134 and section 124b is located in the base 136. The septum 128 may be mounted at an entrance of the section 124b, which would allow it to be replaced as needed by simply detaching the cover 134 from the base 136.

The root of the tooth 102 may be a natural root, as shown in FIGS. 1B and 1C, or may be a dental implant. Referring to FIG. 1E, the natural root of the tooth 102 may be extracted and replaced with a dental implant 138. The crown 106 (previously shown in FIGS. 1B-1D) may be adapted to mate with the dental implant 138. In this case, the dental implant 138 would be provided with a passage 140 that provides communication between the injection port 124 in the crown 106 and the jawbone 100.

Referring to FIG. 1F, drug may be delivered to the injection port 124 using a device such as a hypodermic needle 130 and syringe 132. To deliver the drug, the hypodermic needle 130 is inserted in the injection port 124 and through the septum 128. The hypodermic needle 130 receives a drug from the hypodermic syringe 132 and delivers the drug through the injection port 124 to the chamber 114 and root canal 112a. The drug delivered to the root canal 112a flows through the opening 113 and is absorbed by the jawbone 100.

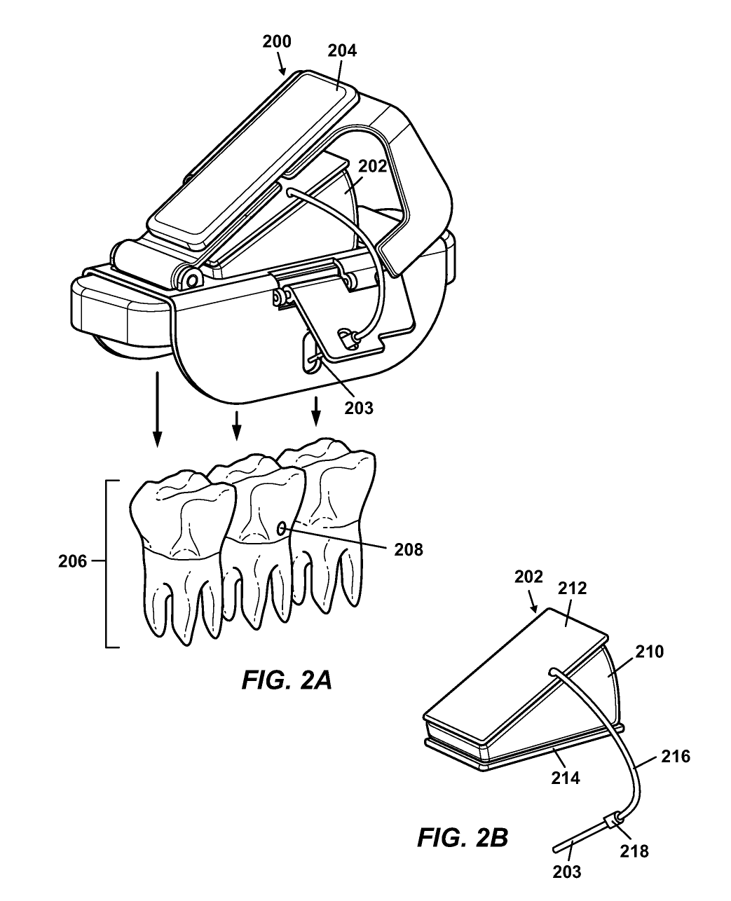

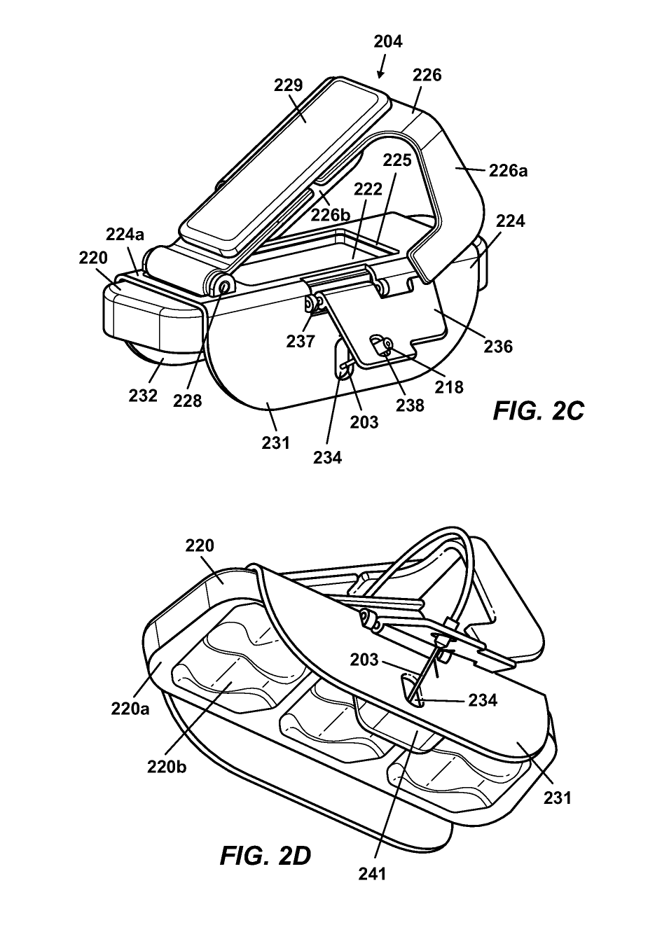

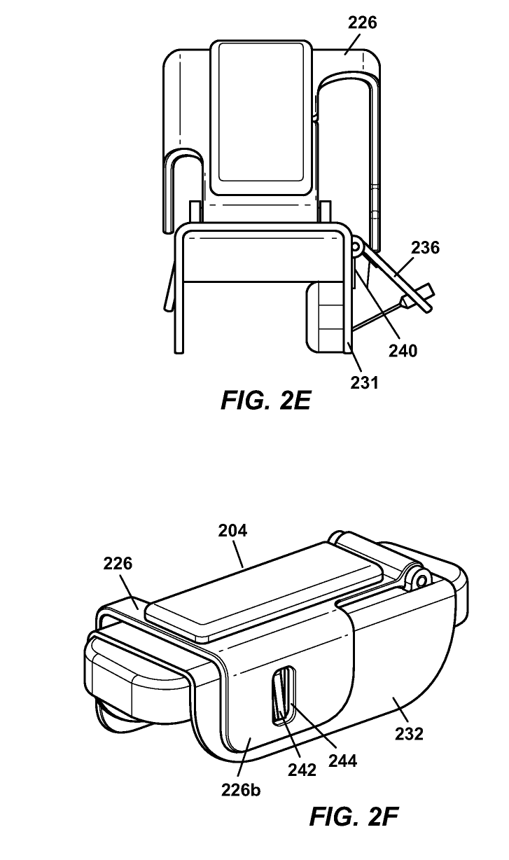

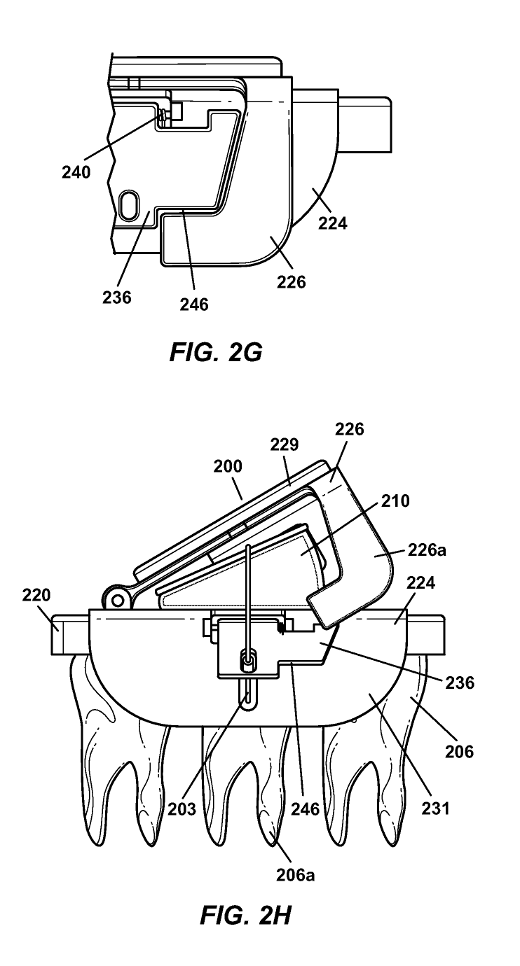

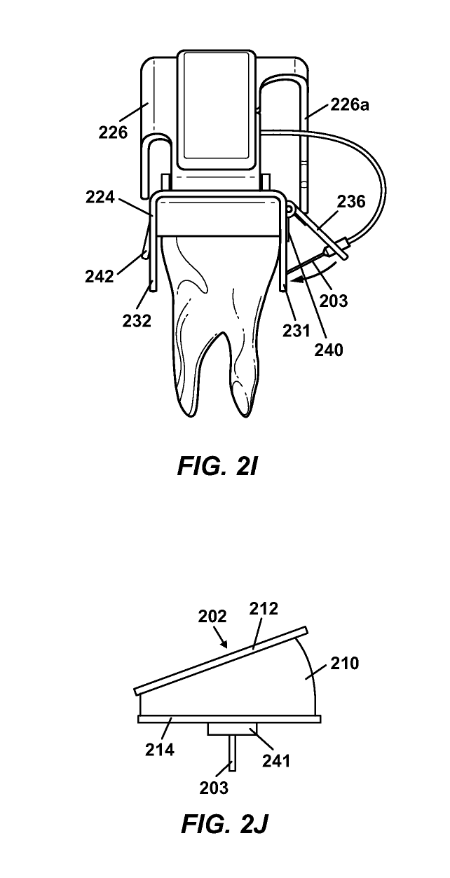

Alternatively, an autoinjector could enhance the convenience control for injecting a drug to the injection port 124. FIG. 2A shows a bite-activated injector 200 according to one embodiment of the invention. The injector 200 includes a drug cartridge 202, an injection needle 203 arranged to receive a drug from the drug cartridge 202, and a press 204 arranged to exert force on the drug cartridge 202, thereby releasing a drug from the drug cartridge 202 into the injection needle 203. In one embodiment, the press 204 is adapted for insertion between a pair of jaws (not shown). In one example, the press 204 can be supported on a set of contiguous teeth 206 in a jawbone (not shown), where at least one of the teeth includes an injection port 208 for drug delivery. Drug is delivered into the injection port 208 through the injection needle 203 by biting down on the press 204. The bite-activated injector 200 thus allows a patient to safely and routinely self-administer a drug into the jawbone by simply biting down on the press 204.

FIG. 2B shows the drug cartridge 202. In one embodiment, the drug cartridge 202 includes collapsible bellows (or bladder) 210 mounted between two rigid plates 212, 214. The collapsible bellows 210 define a drug reservoir that holds a prescribed amount of drug. The collapsible bellows 210 may store a variety of drugs that can be absorbed into a jawbone. Examples of drugs that may be stored in the collapsible bellows 210 include, but are not limited to, insulin, erythropoietin, risperidone, hydromorphone, interferon, and remicaid.

In one embodiment, the drug cartridge 202 further includes a flexible tube 216 having one end connected to the collapsible bellows 210 through an opening in the plate 212 and another end coupled to the injection needle 203 through a needle swivel 218. When the collapsible bellows 210 is compressed, drug flows out of the collapsible bellows 210 into the flexible tube 216 and out through the injection needle 203. The injection needle 203 may be hidden or protected within the bite-activated injector 200 and extended only during bite actuation to better protect the patient.

FIG. 2C shows the press 204. In one embodiment, the press 204 includes a casting 220. The underside (220a in FIG. 2D) of the casting 220 includes dental impressions or indentations (220b in FIG. 2D) which are adapted to mate with the set of teeth (206 in FIG. 2A). The upper surface of the casting 220 includes a recess 222 for receiving the drug cartridge (202 in FIG. 2B). The press 204 also includes a frame 224 mounted on the upper surface of the casting 220. The frame 224 and casting 220 could be separate members or could be integrated into a single unit. The frame 224 includes an opening 225 aligned with the recess 222 in the casting 220. The drug cartridge (202 in FIG. 2B) can be mounted in the recess 222 through the opening 225. A bellows lever 226 is pivotally coupled to a top surface 224a of the frame 224 by, for example, a press pin 228. In general, any suitable connection that allows the bellows lever 226 to pivot relative to the top surface 224a of the frame 224 may be used. A bite surface 229 is formed on an upper surface of the press lever 226. The bite surface 229 is preferably formed of a material that would not damage the teeth when the teeth bear down on the surface. For example, materials for the bite surface 229 include, but are not limited to, silicone, polypropylene, and urethane. In the assembled unit, the collapsible bellows (210 in FIG. 2B) containing a drug is mounted between the bellows lever 226 and the casting 220.

The frame 224 includes side flanges 231, 232. An opening 234 is formed in the side flange 230 for receiving the injection needle 203. A needle lever 236 attaches to the side flange 231 above the opening 234. The needle lever 236 may be attached to the side flange 231 by a lever pin 237 or other suitable connection that allows pivoting of the lever 236 relative to the side flange 231. A torsion spring (240 in FIG. 2F) mounted between the side flange 231 and the lever 236 normally biases the lever 236 away from the side flange 231. The needle lever 236 includes a hole 238 which receives the needle swivel 218. The bellows lever 226 has arms 226a, 226b. Arm 226a engages or contacts the needle lever 236 as the bellows lever 226 is pivoted towards the frame 224. Subsequent pivoting of the bellows lever 226 pivots the needle lever 236 towards the side flange 231. FIG. 2F shows the press 204 in a closed position. In this position, a snap arm 242 on the side flange 232 of the frame 224 snaps into an opening 244 in the arm 226b of the bellows lever 226, thereby locking the bellows lever 226 to the frame 224. In FIG. 2G, a notch 246 on the needle lever 236 releases the bellows lever 226 from the frame 224. When the bellows lever 226 is released, the torsion spring 240 rotates the needle lever 236 back to its original position.

In FIG. 2D, an antiseptic pad 241 is attached to an inner surface of the side flange 231, generally so as to cover the hole 234 from the inside of the side flange 231. As the casting 220 is mounted on the set of teeth (206 in FIG. 2A), the antiseptic pad 241 cleans a surface of the set of teeth, particularly a surface including the injection port (208 in FIG. 2A). The injection needle 203 is also inserted through the antiseptic pad and is thereby cleansed and sterilized prior to being inserted in the injection port. Various agents and drugs may be used as antiseptics. Examples of agents and drugs include, but are not limited to ethanol and chlorhexadine.

FIG. 2H shows the injector 200 mounted on the set of teeth 206. When the casting 220 is mounted on the teeth 206, the injection needle 203 aligns with the injection port (208 in FIG. 2A). The patient can bite down on the bite surface 229 of the bellows lever 226 to begin drug delivery. As the patient bites down on the bite surface 229, the bellows lever 226 compresses the collapsible bellows 210 against the casting 220, squeezing drug out of the collapsible bellows 210 into the injection needle 203. In FIG. 21, the arm 226a of the bellows lever 226a contacts and pivots the needle lever 236 towards the side flange 231, causing the injection needle 203 to be inserted in the injection port so as to deliver the drug to the root system of the tooth. The bellows lever 226 is locked to the side flange 232 of the frame 224 by the snap arm 242 after the drug has been delivered. The bellows lever 226 can be released from the frame 224 using the notch on the needle lever 236. When the bellows lever 226 is released, the torsion spring 240 returns the needle lever 236 to its original position, withdrawing the injection needle 203 from the injection port and allowing the injector 200 to be removed from the teeth.

Various modifications are possible to the bite-activated injector described above. For example, the drug cartridge 202 could be modified as shown in FIG. 2J. In this alternative embodiment, an opening (not visible the drawing) is provided in the plate 214 and the injection needle 203 is mounted at the opening. The injection needle 203 extends below the plate 214, thereby allowing drug to be dispensed from the bottom of the drug cartridge 202. The needle 203 may be telescoping and may be extensible when the press lever (226 in FIG. 2C) is depressed. The antiseptic pad 241 may be mounted at the opening in the plate 214, and the injection needle 203 may extend through the antiseptic pad 241. The antiseptic pad 241 would wipe the surface of the tooth prior to dispensing the drug into the injector port in the tooth. If the injection needle 203 is telescoping, the antiseptic pad could also wipe the injection needle 203 prior to insertion in the injection port. This alternative embodiment is useful for delivering drug when the injection port is located generally vertically in the tooth as illustrated at 124 in FIG. 1C. This alternative embodiment could also eliminate the needle lever mechanism previously described, thereby simplifying the design of the bite-activated injector.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A portal for intraosseous drug delivery, comprising:
a prosthetic body adapted to mate with a tooth; and
a port formed in the prosthetic body such that when the prosthetic body mates with the tooth a route is formed through which a drug can be delivered from an exterior of the prosthetic body to a root of the tooth.

2. The portal of claim 2, further comprising a septum mounted in the port to control passage of unwanted material through the route.

3. The portal of claim 1, wherein the prosthetic body has a tooth crown shape.

4. The portal of claim 1, wherein the prosthetic body is adapted for insertion in an opening in a tooth crown.

5. An injector for intraosseous drug delivery, comprising:
a depressible member adapted for insertion between a pair of jaws;
a drug cartridge including a reservoir relative to adjacent the depressible member such that force can be transferred from the depressible member to the drug cartridge; and
an injection needle in communication with the reservoir;
wherein drug flows from the reservoir into the injection needle when the depressible member is depressed.

6. The injector of claim 5, wherein the depressible member is pivotally coupled to a casting having a plurality of indentations adapted to mate with a set of teeth.

7. The injector of claim 6, wherein the depressible member is pivotally coupled to a frame mounted on the casting, the frame including an opening adapted to receive the injection needle.

8. The injector of claim 7, wherein the opening is aligned with an injection port in the set of teeth when the casting mates with the set of teeth.

9. The injector of claim 8, further comprising an antiseptic pad mounted at the opening.

10. The injector of claim 8, wherein the injection needle is adapted for insertion in the injection port.

11. The injector of claim 6, wherein the casting includes a recess for receiving the drug cartridge.

12. The injector of claim 5, wherein the depressible member includes a bite surface.

13. The injector of claim 7, further comprising a lever pivotally coupled to the frame and having an opening for receiving a swivel coupled to the injection needle.

14. The injector of claim 13, further comprising a spring for biasing the lever away from the frame.

15. The injector of claim 14, wherein the depressible member includes an arm for biasing the lever against the frame such that the injection needle is inserted in the injection port when the depressible arm is depressed.

16. The injector of claim 13, further comprising a snap arm on the frame which locks the depressible member to the frame after the drug is dispensed from the reservoir.

17. The injector of claim 16, wherein the lever includes a notch which allows the depressible member to be released from the frame.

18. The injector of claim 16, wherein the drug cartridge is collapsible.

19. A system for intraosseous drug delivery, comprising:
a reservoir containing a drug;
an injection port which provides a route through which the drug can be delivered to a root of a tooth from an exterior of the tooth; and
an injection needle in communication with the reservoir and adapted for insertion into the injection port.

20. The system of claim 19, further comprising a septum disposed in the injection port to control passage of unwanted material through the route.

21. The system of claim 19, wherein the injection port is located in a crown of the tooth.

22. The system of claim 21, wherein the crown is a prosthetic tooth crown.

23. The system of claim 19, further comprising a mechanism for transferring the drug from the reservoir into the injection needle.

24. A method for intraosseous drug delivery, comprising:
inserting a needle in a portal formed in a tooth embedded in a jawbone; and
dispensing a drug into the portal through the needle such that the drug flows to the jawbone through a channel defined between the portal and the jawbone.

25. The method of claim 24, wherein the channel extends from a chamber in a crown of the tooth to a canal in a root of the tooth.

26. The method of claim 24, wherein the needle is inserted through a septum disposed in the portal.

27. The method of claim 24, wherein dispensing the drug comprises mounting a collapsible drug reservoir on the tooth and biting down on the collapsible drug reservoir to activate flow of the drug from the drug reservoir into the needle.
